(19) United States
(12) Patent Application Publication
(10) Pub. No.: US 2026/0028964 A1
(43) Pub. Date: Jan. 29, 2026

(54) SOLAR WINDMILL FOR JOINT POWER GENERATION

(71) Applicant: PHOS GLOBAL ENERGY SOLUTIONS, INC., Fort Lauderdale, FL (US)

(72) Inventors: Victor Bica, Saint James, NY (US); Eugene Earle Rudolph, Port Jefferson Station, NY (US)

(21) Appl. No.: 18/993,436

(22) PCT Filed: Jul. 11, 2023
(86) PCT No.: PCT/US2023/027366

§ 371 Date: Jan. 10, 2025

Related U.S. Application Data
(60) Provisional application No. 63/388,224, filed on Jul. 11, 2022.

(51) Int. Cl. F03D 9/00; F03D 3/00; F03D 9/11; F03D 9/25; F03D 15/10; F03D 80/70; H02K 7/116; H02K 7/18

(52) U.S. Cl. CPC F03D 9/007; F03D 3/005; F03D 9/11; F03D 9/25; F03D 15/10; F03D 80/70; H02K 7/116; H02K 7/183; F05B 2220/706; F05B 2220/708; F05B 2240/51; F05B 2260/4031

(57) ABSTRACT

A vertical wind turbine generator including a base including a generator housed therein, a magnetic pinion gear connected to the generator via a shaft, a magnetic bull gear in magnetic communication with the pinion gear, a rotating shaft rigidly connected to the magnetic bull gear, a wind turbine blade connected to the rotating shaft and including a photovoltaic (PV) panel, and an energy storage device electrically coupled to the generator and the PV panel, wherein rotation of the wind turbine blade and rotating shaft is transferred to the generator via the magnetic bull gear and magnetic pinion gear to produce electrical energy.

### CROSS-REFERENCE TO RELATED APPLICATIONS

The instant application is a National Phase Filing of PCT/US2023/027366 filed Jul. 11, 2023, which claims priority to U.S. Provisional Application No. 63/388,224 filed Jul. 11, 2022, bearing the title SOLAR WINDMILL FOR JOINT POWER GENERATION. Further, this application is related to Patent Cooperation Treaty Application No. WO 2021/096470 filed Aug. 14, 2020, and PCT/US2022/029255 filed May 13, 2022, the entire contents of which are incorporated herein as if set forth fully particularly the descriptions of flywheels and their various uses for storage and allocation of energy on demand.

### TECHNICAL FIELD

This disclosure relates generally to renewable energy devices, and in particular to a combined solar and wind turbine renewable energy generation device.

### BACKGROUND

Renewable energy has become an increasingly important source of electrical energy generation in many countries around the world. As the demand for electrical energy has increased, the impact of fossil fuels on the environment has become magnified and increasingly apparent. In an effort to overcome these obstacles, advancements in green energy generation have continued to accelerate, resulting in innovations such as hydrodynamic generators, wind turbines, geothermal energy, biomass energy, amongst others. Improvements to the design and function of these systems are always desirable.

### SUMMARY

One aspect of the disclosure is directed to a vertical wind turbine generator. The vertical wind turbine generator includes a base having a generator housed therein. The generator also includes a magnetic pinion gear connected to the generator via a shaft; a magnetic bull gear in magnetic communication with the pinion gear, a rotating shaft rigidly connected to the magnetic bull gear. The generator also includes a wind turbine blade connected to the rotating shaft and including a photovoltaic (PV) panel; and an energy storage device electrically coupled to the generator and the PV panel, where rotation of the wind turbine blade and rotating shaft is transferred to the generator via the magnetic bull gear and magnetic pinion gear to produce electrical energy.

Implementations of this aspect of the disclosure may include one or more of the following features. The vertical wind turbine generator further including a stationary shaft, where the rotating shaft rotates about the stationary shaft. The vertical wind turbine generator further including a brush housing secured to the rotating shaft. The vertical wind turbine generator further including a pair of brushes mounted in the brush housing and in electrical communication with the PV panel. The vertical wind turbine generator further including a cap mounted to the stationary shaft. The vertical wind turbine generator further including at least two pins, each pin configured for electrical communication to one of the pair of brushes while the brushes rotate with the rotating shaft about the at least two pins. The pins are in electrical communication via a wire with an energy storage device such that electrical energy generated by the PV panel is transmitted via the pair of brushes, pins, and wire to the energy storage device. The energy storage device is one or more of a battery, a flywheel, or a supercapacitor. A positive polarity connection of the plurality of PV panels is connected to one of the pair of brushes and a negative polarity connection of the plurality of PV panels is connected to a second of the pair of brushes. The vertical wind turbine generator further including lower bearing proximate the magnetic bull gear and an upper bearing proximate a top of the rotating shaft. The lower bearing and the upper bearing are ball bearings or roller bearings. The magnetic levitating bearing levitates the rotating shaft relative to the stationary shaft. The magnetic levitating bearing includes a top half and a bottom half, and a polarity of magnets in the bottom half is arranged to oppose a polarity of magnets in the top half to levigate the top half relative to the bottom half. The top half is secured to the rotating shaft and the bottom half is secured to the stationary shaft. The top half includes concentric rings of magnets, where each ring has an opposing polarity of its neighboring ring. The bottom half includes concentric rings of magnets, where each ring has an opposing polarity to its neighboring ring, where the concentric rings of the bottom half to limit lateral movement of the concentric rings of the top half. The vertical wind turbine generator further includes a magnetic lift bearing. The magnetic lifting bearing includes a top half and a bottom half, and a polarity of magnets in the top half is arranged to attract a polarity of magnets in the top half to lift the bottom half in the direction of the top half. The top half is secured to the stationary shaft and the bottom half is secured to the rotating shaft.

### BRIEF DESCRIPTION OF THE DRAWINGS

The accompanying drawings, which are incorporated in and constitute a part of this specification, illustrate embodiments of the disclosure and, together with a general description of the disclosure given above, and the detailed description of the embodiments given below, serve to explain the principles of the disclosure, wherein:

FIG. 1 is a front perspective view of a solar wind turbine generator in accordance with the disclosure;

FIG. 2 is a rear perspective view of the solar wind turbine generator of FIG. 1 in accordance with the disclosure;

FIG. 3 is a top perspective view of the solar wind turbine generator of FIG. 1 in accordance with the disclosure;

FIG. 4 is a top view of the solar wind generator of FIG. 1

FIG. 5 is a cross-sectional view of a solar wind turbine generator of FIG. 1 in accordance with the disclosure;

FIG. 6 is a cross-sectional view of a bottom portion of the solar wind turbine generator of FIG. 1 in accordance with the disclosure;

FIG. 7 is a cross-sectional view of a top portion of the solar wind turbine generator of FIG. 1 in accordance with the disclosure;

FIG. 8A is a perspective view of brush housing portion of a solar wind generator in accordance with the disclosure;

FIG. 8B is a perspective view the brush housing portion of a solar wind generator in accordance with the disclosure;

FIG. 9 is a side view of a solar wind generator in accordance with another aspect of the disclosure; and

FIGS. 10A and 10B depict a solar wind generator including a housing in accordance with another aspect of the disclosure.

### DETAILED DESCRIPTION

Embodiments of the disclosure are now described in detail with reference to the drawings in which like reference numerals designate identical or corresponding elements in each of the several views. In the drawings and in the description that follows, terms such as front, rear, upper, lower, top, bottom, and similar directional terms are used simply for convenience of description and are not intended to limit the disclosure. In the following description, well-known functions or constructions are not described in detail to avoid obscuring the present disclosure in unnecessary detail.

This disclosure is directed to vertical wind turbine generators and in particular a wind turbine generator that is constrained in-between passive magnets both radially and vertically. The turbine blades include flexible solar panels connected to them on one or both sides of the turbine blades. The shape or angle of the blades of the vertical wind turbine blades maximize the exposure of the solar panels to the sun's angles from sun rise to sunset, at the same time keeping the optimal angle for the wind flow over the blades to decrease the drag coefficient on the returning blades. A stator is employed to conduct the electrical current generated by the solar panels on the turbine blades while they are rotating to a main inner non-rotating shaft. The wind turbine generator may be connected to a small flywheel that is connected to the dc generator motor via a series of magnetic gears.

Often wind turbines are oriented with their blades spinning about a horizontal axis. The turbine blades are mounted on a mast that allows the blades to rotate such that they face into the wind. While wind turbines with blades rotating about a vertical axis are known, rotation about a horizontal axis may allow for the generation of greater energy due to the use of larger turbine blades. Turbines with blades that rotate about a vertical axis are typically smaller in size and thus generate lower power. That said, turbines that rotate about their horizontal axis have many issues with their production, transport, and installation due to their size, well-known environmental impacts of wildlife such as birds, and local ordinance restrictions due to their noise generation. In contrast, turbines that rotate about a vertical axis, though generating lesser amount of energy, can be easily manufactured, transported, and installed inconspicuously and in many more locations than the larger horizontal axis of rotation turbines.

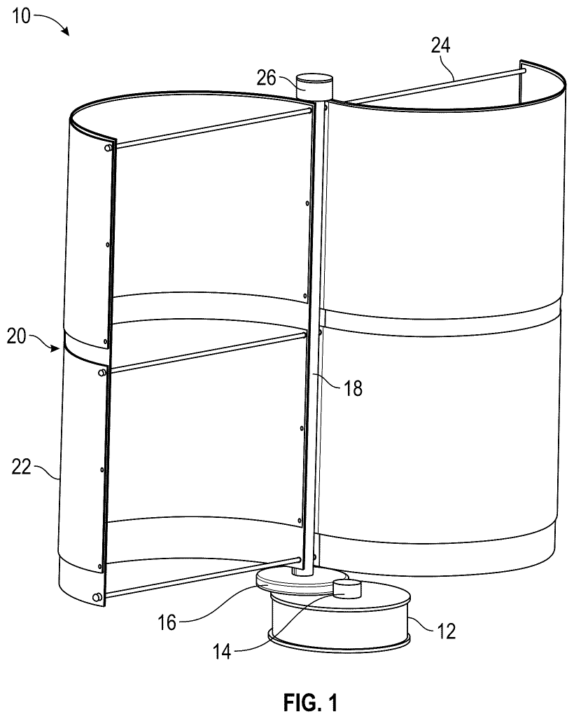

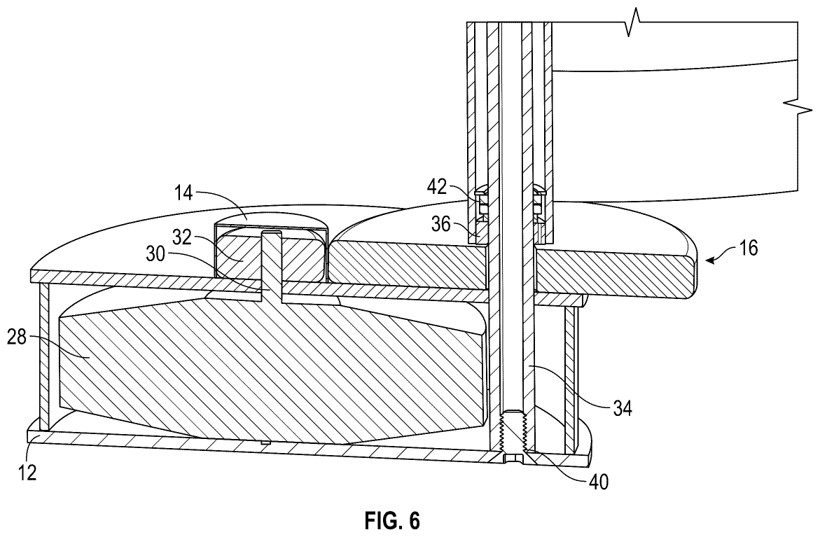

FIG. 1 depicts a vertical wind turbine generator 10 in accordance with the disclosure. The vertical wind turbine generator 10 includes a base 12 housing a direct current (DC) generator, described in greater detail below in connection with FIG. 6. Extending though the base 12 is a shaft 30 (FIG. 6) which connects to a magnetic pinion gear within housing 14. The housing 14 prevents the ingress of water, sand, and other environmental aspects into the base 12 where they could impact the operation of the generator. The magnetic pinion gear is magnetically coupled to a magnetic bull gear 16. The magnetic bull gear 16 is coupled to a rotating shaft 18. Extending from the rotating shaft 18 are the turbine blades 20. As depicted in FIG. 1, the turbine blades 20 are either formed of a flexible photovoltaic (PV) panel 22 or have a flexible PV panel 22 mounted thereon. As depicted in FIG. 1, the turbine blades 20 have an arcuate shape. This arcuate shape can be selected to maximize efficient capture of the wind, while also seeking to maintain the flexible PV panels as unshaded as possible while the turbine blades 20 rotate. Rods 24 are employed to maintain the arcuate shape of the turbine blades 20 and the flexible PV panels 22. Though shown here with PV panels 22 mounted on both sides of the blades 20, the PV panels 22 may be mounted on either side or on both sides without departing from the scope of the disclosure. The PV panels 22 may be mechanically or chemically bonded to the turbine blades 20. In some applications, for example a commercial flat roof, the area around the vertical wind turbine generator 10 may be painted white or another highly reflective coating in order to maximize effective exposure of the PV panels 22 via reflection of the light impacting the roof onto the PV panels 22.

At the top of the rotating shaft 18 is a brush housing 26 within which is housed a bushing mechanism, described in greater detail below, for transferring electrical energy from the flexible PV panels 22 to an energy storage device such as a battery, supercapacitor, or flywheel.

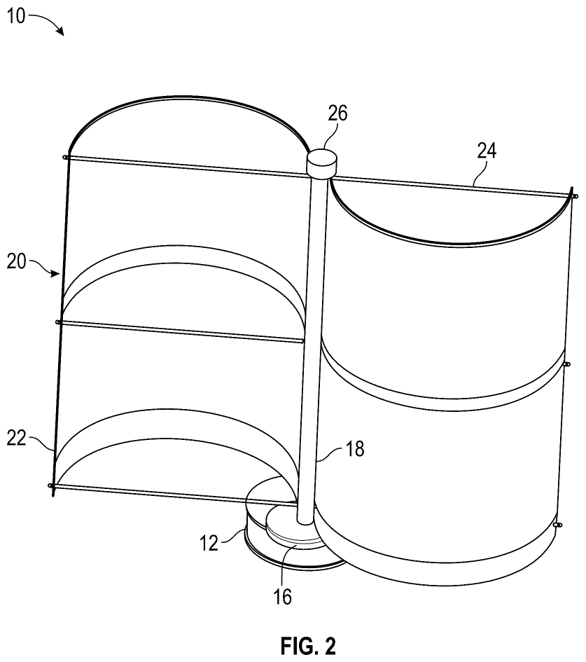

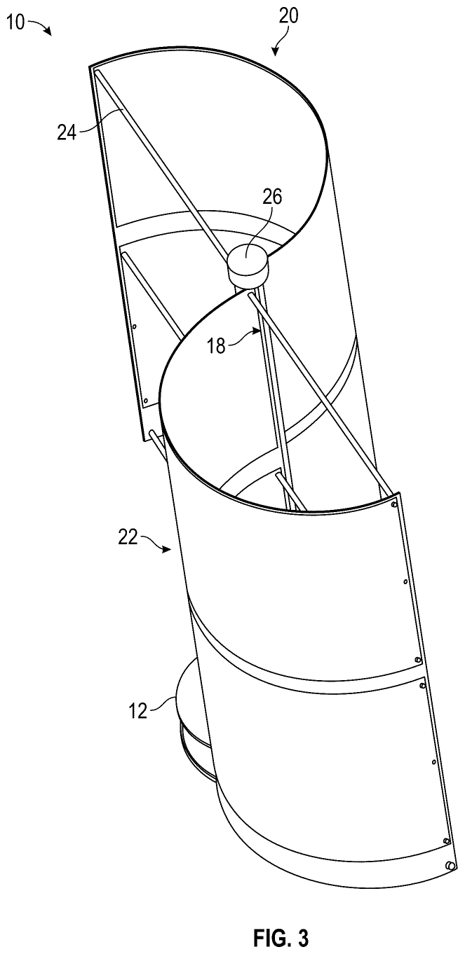

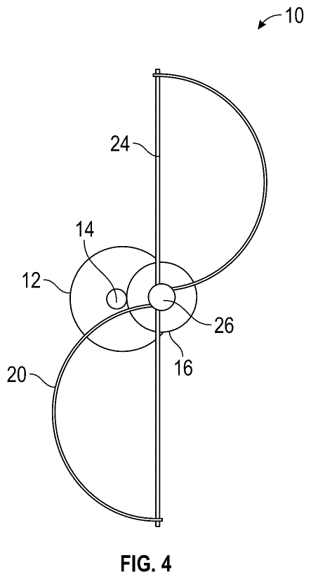

FIG. 2 depicts a rear side view of the vertical wind turbine generator 10. FIG. 3 depicts a top perspective view of the vertical wind turbine generator 10. FIG. 4 depicts a top view of the vertical wind turbine generator 10. These views further depict the relative positioning of the elements of the vertical wind turbine generator 10. Though the base 12 is depicted as being circular, the disclosure is not so limited, and it may take any shape to provide for stability for the vertical wind turbine generator 10 and accommodate the offset nature of the rotatable shaft 18 and magnetic bull gear 16 from pinion gear housing 14 and the magnetic pinion gear housed therein.

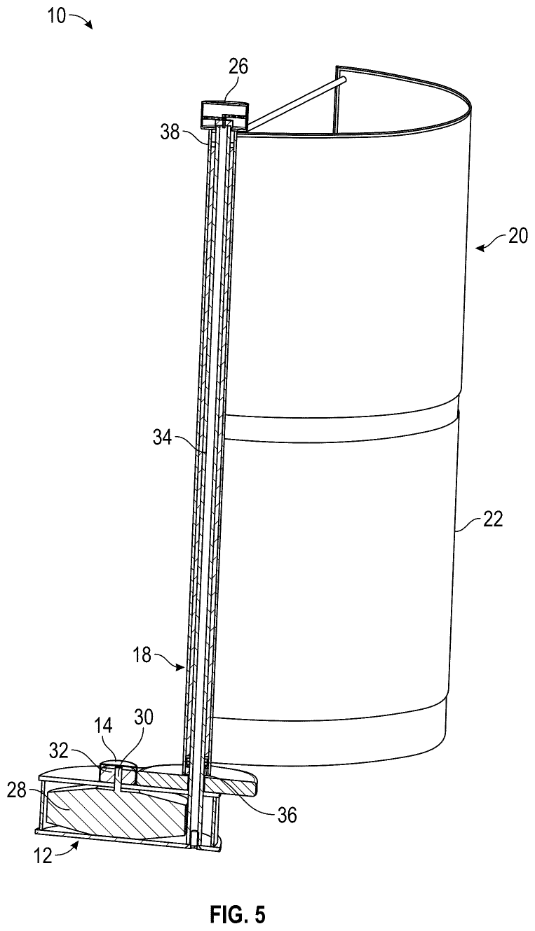

FIG. 5 depicts a cross-sectional view of the vertical wind turbine generator 10. As can be seen the generator 28 is within the housing 12, and a shaft 30 extends from the generator 28 through the housing 12 and connects to a magnetic pinion gear 32 within the magnetic pinion gear housing 14. As noted above the magnetic pinion gear 32 meshes with the magnetic bull gear 16 to transfer rotational motion of the rotating shaft 18 and the turbine blades 20 connected thereto to the generator 28. The generator 28 may be, for example, a direct current (DC) generator an electrically connected to an energy storage device (e.g., a battery, flywheel, or super capacitor).

The magnetic pinion gear 32 and the magnetic bull gear 16 allow for frictionless transmission of motion from the bull gear 16 to the pinion gear 32 as the rotating shaft 18, to which the magnetic bull gear 16 is mounted rotates. In this manner friction of the vertical wind turbine generator is reduced as compared to typical mechanical gears. Each of the magnetic bull gear 16 and the magnetic pinion gear 32 may include a plurality of magnets forming an outer ring of the gear. Each magnet may have an alternating polarity facing outward from the gear. The magnets formed on the periphery of each gear are arranged to be attracted to the polarity of the magnets formed on the opposing gear. In this manner rotation of the magnetic bull gear 16 causes the magnetic pinion gear 32 and the generator 28 connected thereto to rotate. The speed of rotation of the generator 28 is based on the relative size of the magnetic bull gear 16 and the magnetic pinion gear 32 (e.g., the gear ratio). Further, though shown exterior to the housing 12, the magnetic bull gear 16 and magnetic pinion gear 32 may be located within the housing 12 or in a separate housing without departing from the scope of the disclosure. Still further whichever housing the magnetic bull gear 16 and magnetic pinion gear 32 are located, such housing may be under a vacuum to reduce windage associated with rotating gears.

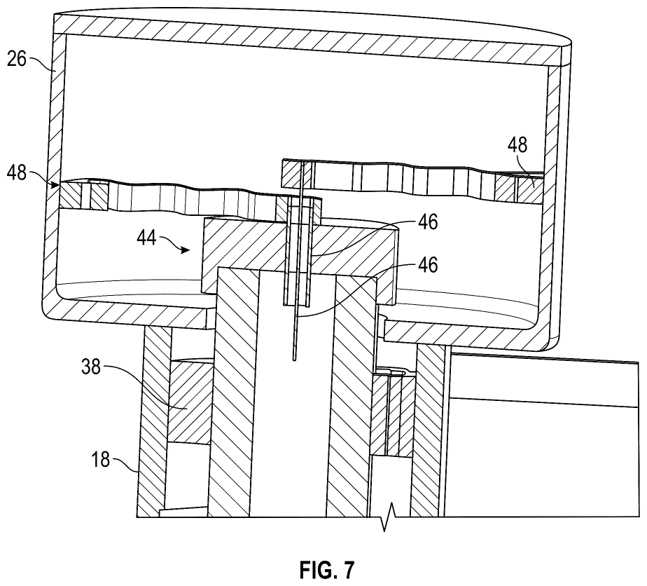

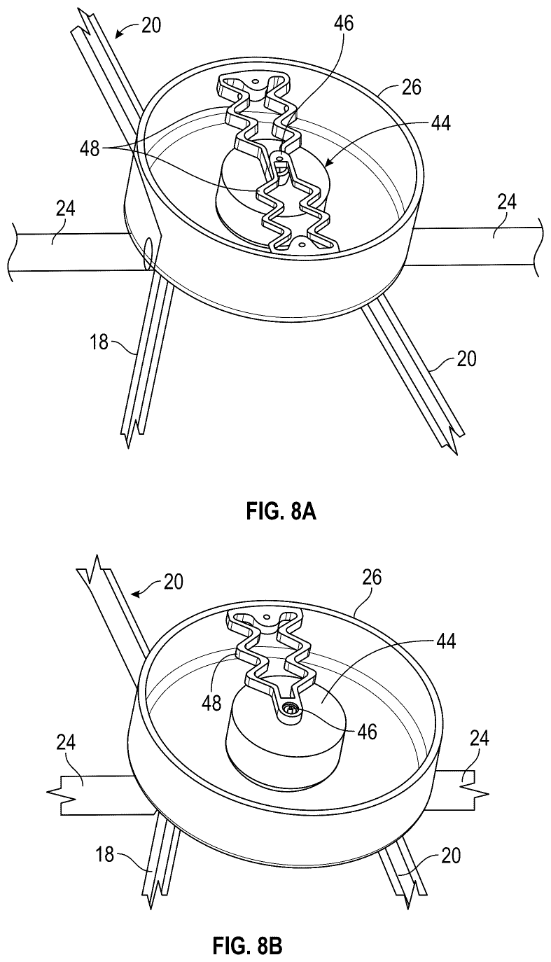

As depicted in FIG. 5, the rotating shaft 18 is mounted on a stationary shaft 34. The stationary shaft 30 is secured in the housing 12 to prevent its movement. A lower bearing 36 enables rotation of the rotating shaft 18 relative to the stationary shaft 34. The lower bearing 36 may be a ball or roller bearing, the inner race of the lower bearing 36 is fixedly mounted to the outer surface of the stationary shaft 34. The outer race of the lower bearing 36 is fixedly mounted to the inner surface of the rotating shaft 18. The lower bearing 36 enables rotation of the rotating shaft 18 relative to the stationary shaft 34, and also absorbs both lateral forces imparted on the vertical wind turbine generator 10 by wind loading of the turbine blades 20 and vertical loads imparted by the weight of the turbine blades 20 and the rotating shaft 18. An upper bearing 38 is mounted similar to the lower bearing 36 allowing relative motion of the rotating shaft 18 and the stationary shaft 34. The brush housing 26 is secured to and rotates with the rotating shaft 18. As will be described in greater detail with respect to FIG. 7-8B, two or more brushes, for example beryllium copper brushes, are mounted with the brush housing 26 and rotate with the brush housing 26 relative to the stationary shaft 34. The brushes are in electrical communication with the positive and negative wires of a cable that extends through the stationary shaft 34 and connects to an energy storage device (e.g., a battery, flywheel, supercapacitor, etc.) not shown.

As shown in FIG. 6 the bottom of the stationary shaft 34 is mounted on a bolt 40 extending through a bottom plate of the housing 12 enabling secure connection of the stationary shaft 34 to the housing 12. Other mounting means such as just a slip fit, or a press fit mounting may be employed without departing from the scope of the disclosure.

As depicted in FIG. 6, a levitating bearing 42 may be optionally included in the vertical wind turbine generator. The levitating bearing 42 is composed of two halves, a top half secured to an inner surface of the rotating shaft 18, and a lower half secured to an outer surface of the stationary shaft 34. To produce levitation, a magnetic pole of the top half faces the same magnetic pole of the bottom half. For example, if the downward facing surface of the top half has a negative polarity, the upward facing surface of the bottom half must also have a negative polarity. The common polarities oppose one another and cause the rotating shaft 18 to be lifted relative to the stationary shaft 34. This levitation reduces at least the vertical load applied to the bottom bearing 36 and the top bearing 38 and bottom. Further, each of the top half and the bottom half may be comprised of rings alternating polarity magnetic material. Each ring of the top half is opposite a ring of the bottom half of the same polarity. Accordingly, the top half may have rings with a downward facing polarities, starting closes to the stationary shaft 18 of N-S-N, while the bottom half rings have a polarity of N-S-N a polarity rings. The alternating polarities of rings of the top half and the bottom half form a radial bearing which prevents the lateral movement of the rotating shaft 18 relative to the stationary shaft 34. Thus, the levitation bearing 42 may be used to replace, or at least reduce the size of the lower bearing 36. The levitation bearing 42 removes the vertical forces caused by the weight of the rotating shaft 18 and turbine blades 20 as well as any lateral loads generated by the wind acting on the turbine blades 20. Though not shown, a similar lift bearing may be employed at the top of the rotating shaft. Those of ordinary skill in the art will recognize that unlike the levitating bearing 42 a lift bearing will have magnets or magnetic material with its polarities arranged to attract as opposed to repel. Thus, if the lift bearing has rings of magnetic material, starting at the stationary shaft 34, the rings of a top half may have polarities of N-S-N, while rings of a bottom half of the lift bearing will have polarities of S-N-S in order to attract the two halves together of the lift bearing towards one another. It will be appreciated that in some instances, both the top bearing 38 and the bottom bearing 36 may be replaced by a levitating bearing 42 and a lift bearing without departing from the scope of the disclosure.

Turning to FIG. 7, the top portion of the vertical wind turbine generator 10 is depicted, and particularly the brush housing 26. The brush housing 26 is secured to the rotating shaft 18, and a portion of the stationary shaft 34 extends into the brush housing 26. A cap 44 is secured to the portion of the stationary shaft 34 extending into the brush housing 26. The cap 44 has two pins 46 extending therethrough and in combination form a stator configured to receive electrical energy generated by the solar panels 22. Mounted to the brush housing 26 are at least two brushes 48. The brushes 48 may be for example beryllium copper brushes. The brushes 48 are electrically connected to the solar panels via one or more wires (not shown). As noted above, the brush housing 26, to which the brushes 48 are secured, is itself secured to and rotates with the rotating shaft 18. The turbine blades 20, and the solar panels 22 associated therewith, rotate with the rotating shaft 34. Accordingly, there is no relative motion of the turbine blades 20 and the rotation shaft 34, or the brush housing 26 attached thereto. Electrical cables or wires (not shown) connect the solar panels 22 to the brushes 48. One of the brushes 48 is configured to electrically connect to a negative pole of the solar panels 22 and one of the brushes 48 is configured to electrically connect to a positive pole of the solar panels 22. In one non-limiting example the solar panels 22 are connected in series, and thus include just a single positive wire and a single negative wire, however, those of ordinary skill in the art will understand that parallel connection of the solar panels 22 is also possible.

Regardless of the electrical connection (series or parallel), the positive wire(s) from the solar panels 22 connect to a one of the brushes 48, and the negative wire(s) from the solar panels 22 connect to the other. Each brush 48 is rotatably connected to a pin 46 of the stator. The brushes 48 are in contact with one of the pins 46 allowing for the transfer of electrical energy through the brush 48 and to the pin 46. The pins 46 are stationary, so despite the contact sufficient to complete the circuit, the materials of the brushes 48 and the pins 46 have sufficient relative lubricity to allow for the brushes 48 to rotate about the pins 46 without damaging either or suffering wear that would break the electrical connection. The pins 46 connect to a cable (not shown) electrically connected to an energy storage device (e.g., a battery, flywheel, or super capacitor). This may be the same energy storage device that the generator 28 is connected to or it may be a separate energy storage device. Further, both the generator 28 and the wire descending from the pins 46 may be connected to a DC bus to which are electrically connected other devices including, inverters, motors, etc.

FIG. 8A depicts a perspective view of the brush housing 26 and the brushes 48 connected to the sidewalls of the brush housing 26. As noted above the cap 44 is mounted on the stationary shaft 34 and does not rotate with the brush housing 26 but in combination with the pins 46 forms a stator about which the brushes 48 rotate and allow for the transfer of electrical energy from the solar panels 22 to the pins 46 and ultimately an energy storage device (not shown). FIG. 8B depicts a perspective view of the brush housing 26 with one of the brushes 48 removed. The spring shape of the brushes 48 as shown assists in maintaining a constant pressure on the pins 46 and accommodates changes associated with thermodynamic expansion and contraction. In a further aspect of the disclosure, the entire brush housing 26 with brushes 48 is designed as a single component enabling faster removal and replacement if needed.

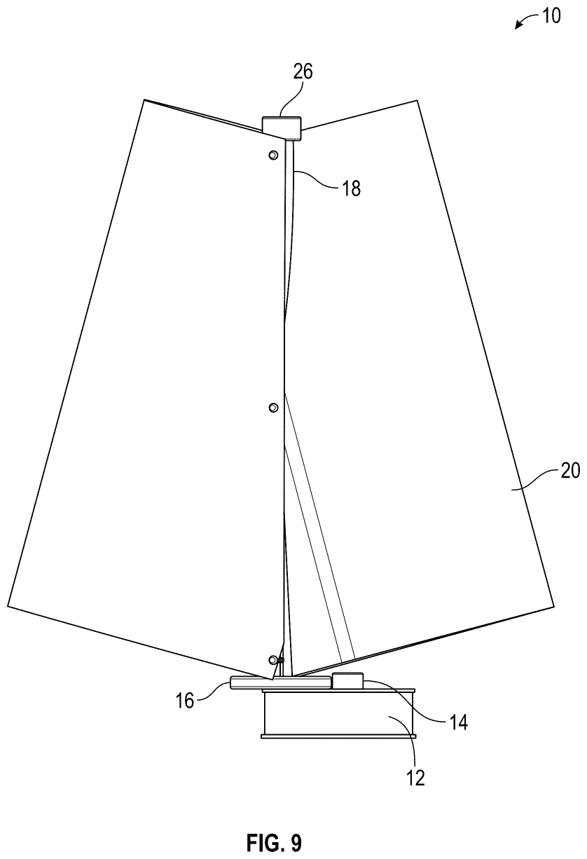

FIG. 9 depicts a further aspect of the disclosure, which may further limit the amount of torque the rotating shaft 18 may place on the bearings 36, 38. In FIG. 9, the turbine blades are angled producing a general cone shape. The cone shape minimizes the projected area at the top of the vertical wind turbine generator, thus reducing the amount of force the wind can apply to the top portion of the vertical wind turbine generator 10. Further, the curvature of the turbine blades 20 need not be uniform but rather may have a cone shape to again provide greater efficiency and reduce loads experiences by the rotating shaft 18 and passed to the stationary shaft 34 as the curvature decreases near the top of the vertical wind turbine generator 10.

The wind turbine generator 10 may be mounted on roofs of buildings, for example on corner areas, or other locations where support columns can bear both the load and any vibrations generated. Further the wind turbine generators 10 may be mounted on poles and other structures without departing from the scope of the disclosure.

It is envisioned that the vertical wind turbine generator 10 of the disclosure expands the traditional limits of energy production experienced by solar power generation (daytime only) and wind generators (when the wind is blowing) to increase the net electrical power generation capabilities. During the day the system benefits from both energy production possibilities, and even at night wind generation remains possible. Accordingly, the vertical wind turbine generator 10 addresses many of the shortcomings of prior systems.

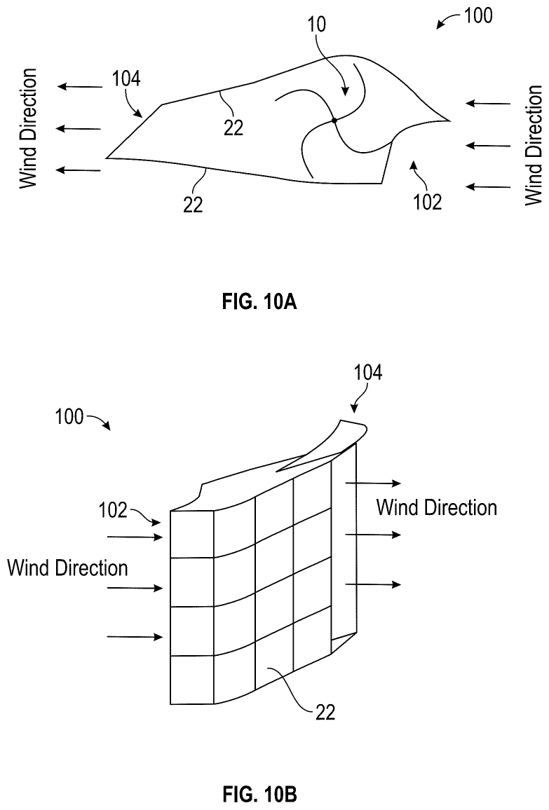

As will be appreciated, with the PV panels 22 rotating, they may in some instances be rotating in and out of the shadow cast by the vertical wind turbine generator 10. Shadow effect of PV panels 22 is a real issue and can result in the output power of the PV panel 22 to drop to 0 W when shaded. To prevent damage to the PV panel 22 when only partially shaded bypass diodes are employed to allow current to by-pass the shaded cells and prevent overheating and damage. In the case of a vertical turbine generator 10, the constant cycling at relatively high speeds may in some instances create cycling issues with the bypass diodes and the solar cells of the PV panel 22 constantly changing from sunny to shaded. The aspect of the disclosure of FIGS. 10A and 10B addresses this challenge.

As shown in FIGS. 10A and 10B, the vertical wind turbine generator 10 is encompassed within a housing 100. The housing 100 includes a leading end 102 and a trailing end 104. The housing is generally open allowing the wind to pass through the housing 100 from the leading end 102 to the trailing end 104. The vertical turbine generator 10 spins freely within the housing, and substantially conforms to the description above. The housing 100 is shaped with the leading end 102 and trailing end 104 with an aerodynamic shape (e.g., a teardrop-like shape) such that the leading end 102 is maintained pointing generally into the wind. For example, an opening in the housing on the leading end 102 may be smaller than on a trailing end 104, which assists in maximizing the wind flow and velocity of the wind flowing through the housing 100. In addition, windvane may also be employed to ensure into the wind pointing of the housing where necessary. Unlike the previously described vertical wind turbine generators 10, the turbine blades 20 do not include the PV panels 22. Rather the PV panels 22 are formed on exterior sides of the housing 100. In this manner, the shade cycling effects of the rotating PV panels 22 can be eliminated and the shading effect minimized or eliminated. Though shown with the sides of the housing 100 being vertical, the disclosure is not so limited and the sides may be flared from a narrower aspect at a top end of the housing 100 to a wider base at a bottom portion of the housing. In this way some of the shading that might occur as a result of PV panels 22 being on a side opposite the location of the sun at any given time can be minimized. Further, though shown with two PV panels forming side walls of the housing 100, the housing 100 may include just a single side wall configured to point the housing into the wind to maximize energy generation from the vertical turbine generator 10. Still further a PV panel 22 may be similarly affixed to a top surface of the housing 100.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of embodiments. Those skilled in the art will envision other modifications within the scope and spirit of the claims appended hereto.

What is claimed is:

1. A vertical wind turbine generator comprising:
a base including a generator housed therein;
a magnetic pinion gear connected to the generator via a shaft;
a magnetic bull gear in magnetic communication with the pinion gear;
a rotating shaft rigidly connected to the magnetic bull gear;
a wind turbine blade connected to the rotating shaft and including a photovoltaic (PV) panel; and
an energy storage device electrically coupled to the generator and the PV panel, wherein rotation of the wind turbine blade and rotating shaft is transferred to the generator via the magnetic bull gear and magnetic pinion gear to produce electrical energy.

2. The vertical wind turbine generator of claim 1, further comprising a stationary shaft, wherein the rotating shaft rotates about the stationary shaft.

3. The vertical wind turbine generator of claim 2, further comprising a brush housing secured to the rotating shaft.

4. The vertical wind turbine generator of claim 3, further comprising a pair of brushes mounted in the brush housing and in electrical communication with the PV panel.

5. The vertical wind turbine generator of claim 4, further comprising a cap mounted to the stationary shaft.

6. The vertical wind turbine generator of claim 5, further comprising at least two pins, each pin configured for electrical communication to one of the pair of brushes while the brushes rotate with the rotating shaft about the at least two pins.

7. The vertical wind turbine generator of claim 6, wherein the pins are in electrical communication via a wire with an energy storage device such that electrical energy generated by the PV panel is transmitted via the pair of brushes, pins, and wire to the energy storage device.

8. The vertical wind turbine generator of claim 7, wherein the energy storage device is one or more of a battery, a flywheel, or a supercapacitor.

9. The vertical wind turbine generator of claim 7, comprising a plurality of PV panels connected electrically in series, wherein a positive polarity connection of the plurality of PV panels is connected to one of the pair of brushes and a negative polarity connection of the plurality of PV panels is connected to a second of the pair of brushes.

10. The vertical wind turbine generator of claim 2, further comprising lower bearing proximate the magnetic bull gear and an upper bearing proximate a top of the rotating shaft.

11. The vertical wind turbine generator of claim 10, wherein the lower bearing and the upper bearing are ball bearings or roller bearings.

12. The vertical wind turbine generator of claim 10, further comprising a magnetic levitating bearing, wherein the magnetic levitating bearing levitates the rotating shaft relative to the stationary shaft.

13. The vertical wind turbine generator of claim 12, wherein the magnetic levitating bearing includes a top half and a bottom half, and a polarity of magnets in the bottom half is arranged to oppose a polarity of magnets in the top half to levigate the top half relative to the bottom half.

14. The vertical wind turbine generator of claim 13, wherein the top half is secured to the rotating shaft and the bottom half is secured to the stationary shaft.

15. The vertical wind turbine generator of claim 14, wherein the top half includes concentric rings of magnets, wherein each ring has an opposing polarity of its neighboring ring.

16. The vertical wind turbine generator of claim 15, wherein the bottom half includes concentric rings of magnets, wherein each ring has an opposing polarity to its neighboring ring, wherein the concentric rings of the bottom half to limit lateral movement of the concentric rings of the top half.

17. The vertical wind turbine generator of claim 12, further comprises a magnetic lift bearing.

18. The vertical wind turbine generator of claim 17, wherein the magnetic lifting bearing includes a top half and a bottom half, and a polarity of magnets in the top half is arranged to attract a polarity of magnets in the top half to lift the bottom half in the direction of the top half.

19. The vertical wind turbine generator of claim 18, wherein the top half is secured to the stationary shaft and the bottom half is secured to the rotating shaft.

20. The vertical wind turbine generator of claim 14, wherein the top half includes concentric rings of magnets, wherein each ring has an opposing polarity of its neighboring ring wherein the concentric rings of the bottom half to limit lateral movement of the concentric rings of the top half.
